(19) United States
(12) Patent Application Publication
(10) Pub. No.: US 2025/0233225 A1
(43) Pub. Date: Jul. 17, 2025

(54) BATTERY CELL HOUSING FOR FORMING A BATTERY CELL FOR AN ENERGY STORAGE DEVICE OF A MOTOR VEHICLE, BATTERY CELL FOR AN ENERGY STORAGE DEVICE OF A MOTOR VEHICLE, ENERGY STORAGE DEVICE FOR A MOTOR VEHICLE AND MOTOR VEHICLE

(71) Applicant: AUDI AG, Ingolstadt (DE)

(72) Inventors: Uwe GERLINGER, Kipfenberg (DE); Carsten LORENZ, Reichertshofen (DE); Eduard MAIN, Buxheim (DE)

(73) Assignee: AUDI AG, Ingolstadt (DE)

(21) Appl. No.: 18/967,987

(22) Filed: Dec. 4, 2024

(30) Foreign Application Priority Data
Jan. 12, 2024 (DE) 102024100952.7

(51) Int. Cl. H01M 10/613; B60L 50/60; B60L 50/64; H01M 10/625; H01M 10/647; H01M 10/6568; H01M 50/103

(52) U.S. Cl. CPC H01M 10/613; B60L 50/64; B60L 50/66; H01M 10/625; H01M 10/647; H01M 10/6568; H01M 50/103

(57) ABSTRACT

A battery cell housing for forming a battery cell for an energy storage device of a motor vehicle. The battery cell housing has at least one receiving chamber in its interior for receiving at least one active material unit. The receiving chamber is delimited on the outside by at least one housing wall, the housing wall has at least one cooling chamber for guiding a cooling fluid provided for cooling the active material unit. At least one portion of the housing wall is plastically or elastically deformable, so that an expansion of the active material unit due to the charging cycle and/or aging causes a deformation of the housing wall such that the cross-section of the cooling chamber is reduced at least in portions.

### FIELD

The present invention relates to a battery cell housing for forming a battery cell for an energy storage device of a motor vehicle, wherein the battery cell housing has in its interior at least one receiving chamber for receiving at least one active material unit, wherein the receiving chamber is delimited to the outside by means of at least one housing wall, wherein the housing wall has at least one cooling chamber for guiding a cooling fluid provided for cooling the active material unit.

### BACKGROUND

Motor vehicles with an electric drive, so-called electric vehicles, are becoming increasingly important. In electric vehicles, traction torque is generated by an electric machine or an electric motor. If the traction torque is generated exclusively by means of the electric machine, the vehicle is referred to as a purely electric vehicle. If the traction torque is also generated by means of an internal combustion engine, it is called a hybrid vehicle.

In connection with electric vehicles, a number of technological challenges arise, in particular with regard to the storage of electrical energy on the vehicle side, which is necessary in this context. For this purpose, rechargeable electrical energy storage devices or accumulators or energy storage devices are provided which have multiple battery cells with an electrochemically active material. The energy storage unit is connected to the electric machine so that energy is made available to generate the traction torque. Energy storage systems with a high storage capacity are desirable in order to achieve a long range of the vehicle.

A problem associated with energy storage devices is the fact that they heat up during operation, especially during charging or when transferring energy to the electric machine. However, the temperature of the energy storage device should not exceed certain limits in order to ensure the longest possible service life. In the worst case, an energy storage device could catch fire or be damaged if it is heated excessively, which could lead to the release of substances that are harmful to health and/or the environment. It is therefore of great importance to cool energy storage systems in motor vehicles, wherein in addition to indirect cooling, which is achieved, for example, by means of airflow, direct cooling is often provided. In direct cooling, a cooling fluid is actively pumped to the energy storage unit for cooling.

Another problem with electrical energy storage is that the volume of the battery cells does not always remain constant over their lifetime. Such an increase in volume, also known as “swelling” can occur, for example, during charging and discharging. An age-related increase in volume of the battery cell often occurs. Corresponding volume increases or expansions should be taken into account with regard to the installation space.

With regard to both problems, i.e. the cooling requirement as well as the swelling, possible solution concepts are known from the prior art. EP 3 956 931 B1 discloses an energy storage device with prismatic electrochemical cells and a heat exchanger. The heat exchanger is integrated into a cooling circuit so that heat is dissipated from the cells. Walls of a housing for the cells include thermally conductive inserts to homogenize heat dissipation. The inserts are designed to withstand volume expansion during charging or discharging of the cell.

CN 2 17 903 227 U discloses a battery cell having an outer housing with a cooling chamber and an inner housing with electrochemically active material. To allow for expansion of the electrochemically active material, a gap is provided between the lateral surfaces of the housing.

### SUMMARY

The object of the invention is to provide an improved concept in connection with an energy storage device of a motor vehicle, particularly with regard to cooling and the problem of swelling.

According to the invention, the object is achieved in a battery cell housing of the type mentioned at the outset in that at least one portion of the housing wall is plastically or elastically deformable, so that an expansion of the active material unit due to the charging cycle and/or aging causes a deformation of the housing wall such that the cross section of the cooling chamber is reduced at least in portions.

The invention is based on the idea of providing a common and synergistic means of solving both problems. On the one hand, the cooling chamber contains the cooling fluid for cooling the active material unit. On the other hand, the cooling chamber serves as a compensating volume that enables volume compensation in case of an expansion-related volume change of the active material unit. The cooling fluid can be a coolant, such as water and/or glycol.

The occurrence of swelling causes an expansion or enlargement of the volume of the active material unit and an increasing space requirement for the same. In the battery cell housing according to the invention, this increasing space requirement is compensated or balanced, in particular completely, by reducing the cross-section of the cooling chamber. Thus, the increase in the volume of the active material unit leads to at least a local deformation of the housing, in particular such that the receiving chamber bulges towards the cooling chamber in the region in which the active material unit inflates. In the cooling chamber, this causes a narrowing or tapering in this region. In summary, the expansion of the active material unit causes a reduction in the size of the cooling chamber, partially or completely compensating for this enlargement.

The functionality of the cooling chamber with regard to the guidance of the cooling fluid is essentially not impaired by the reduction in size. Thus, the volume flow of the cooling fluid required to achieve a sufficiently high cooling performance can in principle also be generated in the case of a reduction in the cross-section of the cooling chamber, namely by at least locally increasing the flow velocity. For this purpose, a coolant pump with sufficient power must be provided. Furthermore, in order to maintain the cooling effect, it is necessary that the structural integrity of the housing wall is fundamentally maintained, i.e. that the cooling chamber and the receiving chamber remain fluid-tight. This is achieved by the expansion of the active material unit causing the plastic or elastic deformation of the housing wall. This means that the material of the housing wall, at least in the region affected by the deformation, is sufficiently elastic, flexible or tough so that a deformation occurring as part of a typically occurring expansion of the active material unit does not lead to a material breakage.

The battery cell housing comprises the receiving chamber into which the active material unit is inserted, in particular pushed, during the manufacture of the battery cell. The receiving chamber can have an opening at least on one side, which can be closed after the active material unit has been inserted by means of a closure, for example a lid-like closure. In this way, a preferably liquid-tight sealing of the receiving chamber can be provided, for example to prevent the leakage of a liquid from the active material unit. Preferably, the shape of the receiving chamber and the shape of the original or non-expanded active material unit are the same, so that the active material unit can be inserted into the receiving chamber with a precise fit, i.e. without any remaining free spaces.

The active material unit forms the electrochemically active part of the battery cell for generating a voltage difference. The active material unit is in particular layered and can form a lithium-ion accumulator or another type of battery.

It is conceivable that the housing wall has at least one inner wall and at least one outer wall, wherein the cooling chamber or one of the cooling chambers is arranged between the inner wall and the outer wall. According to this embodiment, the housing wall is multi-layered or has a sandwich-like structure in which the cooling chamber is located between the inner and outer wall. An inner surface of the inner wall can delimit the receiving chamber at least in portions. An outer surface of the inner wall and/or an inner surface of the outer wall can delimit the cooling chamber at least in portions. An outer surface of the outer wall can form, at least in portions, an outer surface of the battery cell housing. The inner wall has the highest possible thermal conductivity in order to ensure the most effective heat transport from the active material unit to the cooling fluid.

It is conceivable that the inner wall and the outer wall are connected to each other via at least one connecting component. The connecting component creates a mechanical connection or coupling between the inner wall and the outer wall. The connecting component can be web-like, i.e. it can be a band or strip that is connected to the inner wall and the outer wall, for example at its lateral end faces.

Particularly preferably, the housing wall has multiple cooling chambers. At least some of the cooling chambers can be fluidically independent of each other. Preferably, at least some of the cooling chambers, in particular all cooling chambers, communicate fluidically with each other. In this way, a cooling fluid stream can stream or flow through the corresponding cooling chambers successively. The cooling fluid flow can branch at least in parts and be rejoined. The cooling chamber or at least one of the cooling chambers can have an elongated or oblong geometry and thus form a cooling channel.

At least two separate cooling chambers are conceivable, which are separated from each other by means of the connecting component. The connecting component can not only ensure the structural integrity of the battery cell housing, but also delimit the cooling chambers. It is conceivable that multiple connecting components designed as webs, bands or strips run parallel to one another, so that the cooling chambers are also arranged parallel and side by side. The cooling fluid can flow through these cooling chambers in parallel or successively, in particular in a meandering manner.

Preferably, the advantageous effect of balancing the volumes described above occurs while the outer contour or shape of the battery cell housing remains the same, so that its space requirement does not change. In particular, to realize this advantage, it is conceivable according to the invention that the outer wall has a higher mechanical strength than the inner wall. If the connecting component is also provided, it is conceivable that the outer wall has a higher mechanical strength than the connecting component. The different strengths, such as different elastic constants, can be achieved by using different materials and/or different thicknesses, in particular different wall thicknesses of the inner wall and the outer wall. Thus, according to this embodiment, the expansion of the active material unit is effected approximately exclusively by means of the deformation of the inner wall and, if applicable, the connecting component.

In addition or alternatively, the consistency of the outer contour can be achieved by arranging the battery cell in a form-fitting manner or without play in a receiving space which is at least approximately rigid and thus retains its original shape even when swelling occurs. In this case too, the expansion of the active material unit is correspondingly effected approximately exclusively by means of the deformation of the inner wall and, if present, of the connecting component. The rigid receiving space can be provided by an energy storage housing into which the battery cell housing or the respective battery cell is inserted.

The battery cell housing according to the invention can be in one piece. This means that the battery cell housing consists of a continuous body or material and is free of joints or seams. The absence of such joints or seams prevents a reduction in the mechanical strength of the battery cell housing. In addition, the one-piece battery cell housing is generally easy to manufacture.

The battery cell housing can be made of a metal, such as aluminum, or a plastic, such as PET. The battery cell housing can be manufactured by means of an extrusion process or a profile extrusion method. In these methods, a continuous strand with a specific cross-sectional shape is produced, which must be cut at the respective points depending on the desired length of the battery cell housing.

Thus, it is fundamentally conceivable and, in the case of the embodiment described in the previous description passage, it is in any case provided that the at least one receiving chamber and the at least one cooling chamber extend parallel along a longitudinal direction of the battery cell housing, wherein the cross-sectional area of the battery cell housing is constant along the longitudinal direction. The receiving chamber and the cooling chamber are initially open on both sides at the front ends of the battery cell housing. To close these chambers, at least the receiving chamber, a closure, in particular a lid-like closure, can be provided on both sides.

According to the invention, it can be provided that the geometric shape of the receiving chamber is prismatic or cylindrical, so that the active material unit having a prismatic or cylindrical shape can be received therein, in particular with a precise fit and thus without play. Regarding the prismatic shape, a cuboid shape is conceivable. The cuboid shape can be plate-like, so that two opposite outer surfaces of the active material unit form a large part of the entire outer surface. The at least one cooling chamber can also have a, in particular elongated, cuboid shape, in particular in the case of the cuboid-shaped battery cell housing. Regarding the cylindrical shape, it is conceivable that this is the shape of a right circular cylinder. In this embodiment, the housing wall has the shape of a hollow cylinder, wherein the at least one cooling chamber can have the cross-sectional shape of a circular arc.

Preferably, the housing wall having the cooling chamber delimits the receiving chamber laterally, in particular on the entire circumference. Thus, the receiving chamber can have front sides, which are in particular open or closed by the closure, the areas of which are significantly smaller than the lateral surfaces. Thus, the lateral limitation of the receiving chamber by means of the housing wall ensures that the cooling effect is as efficient as possible due to the contact surface present in this region between the active material unit and the housing wall. In addition, the swelling usually affects the lateral region of the active material unit particularly strongly or exclusively, so that the compensation effect described is increasingly required in this region.

The present invention further relates to a battery cell for an energy storage device of a motor vehicle, comprising a battery cell housing according to the preceding description and an active material unit accommodated in the receiving chamber of the battery cell housing. All advantages, features and aspects explained in connection with the battery cell housing according to the invention are equally transferable to the battery cell according to the invention and vice versa.

Furthermore, the present invention relates to an energy storage device for a motor vehicle, comprising multiple storage cells for storing electrical energy, wherein at least one of the storage cells is a battery cell according to the preceding description passage. All advantages, features and aspects explained in connection with the battery cell housing according to the invention are equally transferable to the battery cell according to the invention and vice versa.

With regard to the energy storage device according to the invention, it can be provided that the storage cells are arranged within an energy storage housing, in particular a cuboid-shaped one. The energy storage housing forms or comprises a receiving space for the storage cells. The storage cells arranged in the receiving space can be electrically contacted with one another by means of electrical connecting means, in particular in the context of a series and/or parallel connection. The energy storage housing, which is made of metal, for example, protects the storage cells from the outside, especially with regard to mechanical stress and other undesirable influences such as moisture. The energy storage housing can have a structure comprising multiple compartments, which is formed, for example, by longitudinal and/or transverse webs, wherein the storage cells are arranged in these compartments.

The energy storage device can have at least one supply interface and at least one discharge interface, wherein a cooling fluid guided in a cooling system of the motor vehicle can be supplied to the energy storage device via the supply interface and discharged from the latter via the discharge interface. The energy storage device can have a distribution unit which distributes the cooling fluid supplied via the supply interface to the cooling chambers. The energy storage device may comprise a collection unit which collects the cooling fluid distributed to the cooling chambers towards the discharge interface.

Finally, the invention relates to a motor vehicle comprising an electric machine and an energy storage device connected to the electric machine according to the preceding description passages. The electric machine is designed to generate a traction torque for the motor vehicle by means of electrical energy stored in the traction storage device. All advantages, features and aspects explained in connection with the battery cell housing according to the invention, the battery cell according to the invention and the energy storage device according to the invention are equally transferable to the motor vehicle according to the invention and vice versa.

It is conceivable that the traction torque is generated exclusively by means of the electric machine, so that the motor vehicle is a purely electric vehicle. It is also conceivable that the traction torque is additionally generated by means of an internal combustion engine, so that the motor vehicle is a hybrid vehicle.

In the motor vehicle according to the invention, a cooling system forming a cooling circuit and carrying the cooling fluid can be provided, into which the cooling chamber is integrated. It is conceivable that at least one coolant pump for driving the circulation of the cooling fluid and at least one cooling device, which is for example a condenser or a heat exchanger, by means of which heat can be dissipated from the cooling fluid, are integrated into the cooling circuit.

### BRIEF DESCRIPTION OF THE FIGURES

Further advantages, features and details of the present invention are obtained from the exemplary embodiments explained in the following and from the figures. In particular, schematically:

FIG. 1 shows a schematic plan view of a motor vehicle according to the invention according to an exemplary embodiment, having an energy storage device according to the invention according to an exemplary embodiment,

FIG. 2 shows a cross-sectional view of a battery cell housing according to the invention according to an exemplary embodiment for forming a battery cell according to the invention according to an exemplary embodiment, which is a component of the energy storage device of the motor vehicle of FIG. 1,

FIG. 3 shows a schematic, perspective view of an active material unit which is to be inserted into the battery cell housing of FIG. 2 to form the battery cell,

FIG. 4 shows a cross-sectional view of the energy storage device of the motor vehicle of FIG. 1 with battery cells with battery cell housings which are modified with respect to FIG. 2, before the occurrence of swelling, and

FIG. 5 shows the same representation as FIG. 4 after the occurrence of swelling.

### DETAILED DESCRIPTION

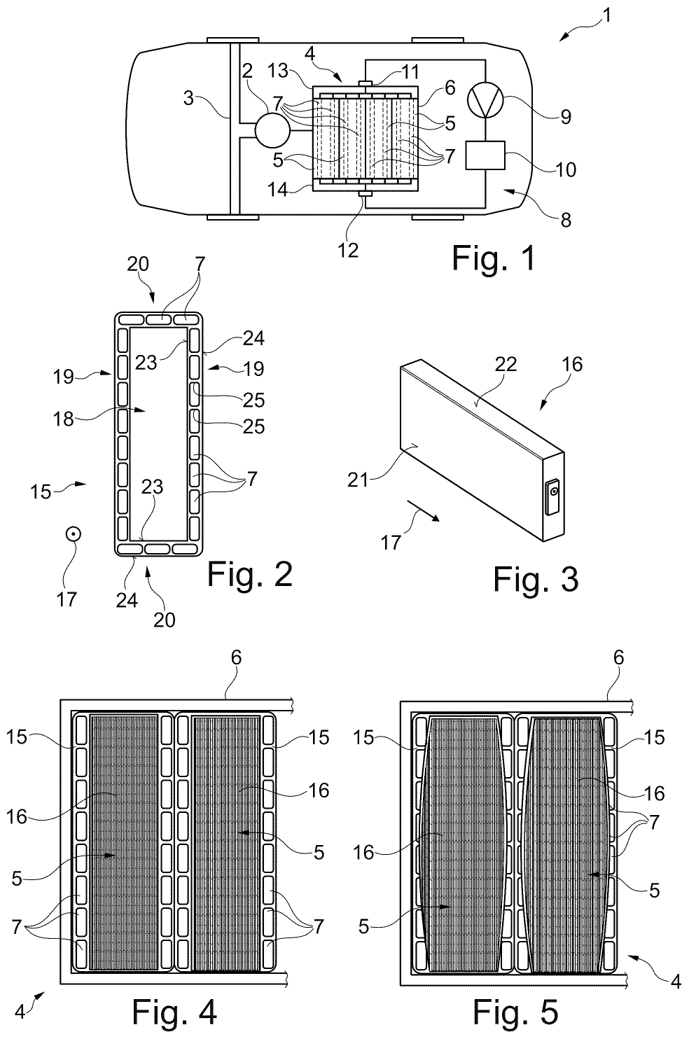

FIG. 1 shows a plan view of a motor vehicle 1 according to the invention, which is an electric vehicle and thus comprises an electric machine 2 provided for generating a traction torque. The traction torque can be transmitted from the electric machine 2 to the wheels of the motor vehicle 1 via a drive train 3. Optionally, the motor vehicle 1 additionally comprises an internal combustion engine for generating the traction torque.

The electrical energy required to operate the electric machine 2 is stored in a rechargeable energy storage device 4 according to the invention of the motor vehicle 1. The energy storage device 4 comprises multiple storage cells designed as battery cells 5 according to the invention. The battery cells 5 are accommodated in an interior of a cuboid-shaped energy storage housing 6 made of metal, in this case steel, which forms a receiving space. To cool the energy storage device 4, the battery cells 5 each have a plurality of cooling chambers 7 designed as cooling channels, wherein in FIG. 1, for the sake of clarity, only two of the cooling chambers 7 are indicated by dashed lines.

The energy storage device 4 or the cooling chambers 7 are integrated into a cooling system 8 of the motor vehicle 1, which forms a cooling circuit and carries a cooling fluid. The cooling fluid circulating in the cooling system 8 is, for example, a water-glycol mixture. The cooling system 8 has a coolant pump 9, by means of which the cooling fluid can be conveyed, and a cooling device 10, which is for example a condenser and/or a heat exchanger and by means of which heat can be dissipated from the cooling fluid. The energy storage device 4 has a supply interface 12, via which the cooling fluid can be supplied to the energy storage device 4, and a discharge interface 11, via which the cooling fluid can be discharged from the energy storage device 4. A distribution unit 14 distributes the cooling fluid supplied via the supply interface 12 to the cooling chambers 7. A collection unit 13 brings the cooling fluid distributed to the cooling chambers 7 together to the discharge interface 11 after it has flowed through the cooling chambers 7.

Details regarding the battery cells 5 are explained below using FIGS. 2 and 3. Thus, each of the battery cells 5 comprises a battery cell housing 15 according to the invention and an active material unit 16. A cross-sectional view of the battery cell housing 15 running perpendicularly with respect to a longitudinal direction 17 is shown in FIG. 2. FIG. 3 shows a perspective view of the active material unit 16. The active material unit 16 forms the electrochemically active part of the respective battery cell 5 for generating a voltage difference. In the present case, the active material unit 16 is layered and forms a lithium-ion battery.

The battery cell housing 15 is a one-piece component made of aluminum, which was manufactured by means of an extrusion process. Alternatively, the battery cell housing 15 may be made of a plastic and manufactured by means of a profile extrusion process. The geometric shape of a receiving chamber 18 of the battery cell housing 15, in which the active material unit 16 is to be inserted to form the battery cell 5, and of the battery cell housing 15 is prismatic, namely flat and cuboid-shaped. The shape of the receiving chamber 18 corresponds to the shape of the active material unit 16, so that the latter can be inserted into the receiving chamber 18 with a precise fit and without play. With regard to the geometric shapes mentioned, shapes deviating from these, such as a cylindrical shape, are also conceivable according to the invention.

Since the battery cell housing 15 produced by means of the extrusion process is initially open at the front, the receiving chamber 18 of the resulting battery cell 5 is to be closed on both sides via a lid-like closure, which is not shown in detail in the figures.

The battery cell housing 15 has four lateral housing walls 19, 20, each of which extends perpendicular to the initially open end faces of the battery cell housing 5. Specifically, two opposing, large-area housing walls 19 and two opposing, small-area housing walls 20 are provided. After the active material unit 16 has been inserted into the receiving chamber 18, the large-area housing walls 19 are each in contact with one of the large-area outer surfaces 21 of the active material unit 16 and the small-area housing walls 20 are in contact with a small-area outer surface 22 of the active material unit 16.

Details regarding the housing walls 19, 20 having the cooling chambers 7 are explained below with reference to FIG. 2. The housing walls 19, 20 each have an inner wall 23 and an outer wall 24, which are connected to one another via web-like connecting components 25. The inner walls 23 delimit the receiving chamber 18. The outer walls 24 form a lateral outer surface of the resulting battery cell 5. The connecting components 25 separate the cooling chambers 7 from each other in pairs. The cooling chambers 7 are flowed through by the cooling fluid in parallel, but can also be flowed through one after the other, for example in a meandering manner. The cooling chambers 7 are initially open at the front and are each connected there in a fluid-tight manner to the distribution unit 13 or collection unit 14.

Reference is now made to FIG. 4, which shows a cross-sectional view of a portion of the energy storage device 4. This comprises multiple battery cells 5, of which only two are shown in FIG. 4 for reasons of clarity. It can be seen that the battery cells 5 are accommodated with a precise fit and without play in the receiving space of the energy storage housing 6. As already mentioned, a battery cell housing 15 and an active material unit 16 according to FIGS. 2 and 3 were used to form the battery cells 5, with a modification being made with regard to the battery cell housing 15 in that the cooling chambers 7 are only provided in the large-area housing walls 19, in particular since these are in touching contact with the large-area outer surfaces 21 of the active material unit 16 and thus a sufficiently efficient heat transfer from the active material unit 16 to the cooling fluid takes place.

While FIG. 4 shows the energy storage device 4 immediately after its production, FIG. 5 shows the same energy storage device 4 in which the active material units 16 have expanded laterally and a so-called “swelling” has taken place. Such expansions may occur during charging of the energy storage device 4 or due to aging. The expansion of the active material units 16 causes a deformation of the respective housing walls 19 having the cooling chambers 7. As a result, the cross-section of the cooling chambers 7 arranged in the region of expansion is reduced at least in portions. The receiving chamber 18 is thus enlarged in this region, this enlargement being compensated by the reduction in size of the cooling chambers 7.

The described deformation of the housing walls 19, 20 takes place plastically or elastically, so that the receiving chamber 18 and the affected cooling chambers 7 only experience a change in their shape, but their structural integrity is maintained. This means that no material failure or breakage occurs in the region of deformation, so that the fluid tightness of the chambers 7, 18 is maintained. The cooling effect of the cooling chambers 7 affected by the tapering is maintained because, due to the coolant pump 9, the throughput or volumetric flow of the cooling fluid flowing through the cooling chambers 7 is kept at a sufficiently high level.

In the present case, an outer contour or shape of the battery cell housing 15 also remains at least approximately the same or constant despite the expansion of the active material units 16. On the one hand, this results from the form-fitting, precisely fitting accommodation of the battery cells 5 in the energy storage housing 6, wherein the mechanical stability of the energy storage housing 6 counteracts any corresponding deformation. On the other hand, this is caused by the fact that in this case the outer wall 24 has a higher mechanical strength than the inner wall 23 and the connecting components 25. Although this is not apparent in the figures, the difference in mechanical strength is due to the fact that the thickness or strength of the outer wall 24 is significantly greater than that of the inner wall 23 and the connecting components 25. In principle, this different mechanical strength can also be realized using different materials for the respective portions of the housing wall 19, 20.

1. A battery cell housing for forming a battery cell for an energy storage device of a motor vehicle, wherein the battery cell housing has in its interior at least one receiving chamber for receiving at least one active material unit, wherein the receiving chamber is delimited on the outside by at least one housing wall, wherein the housing wall has at least one cooling chamber for guiding a cooling fluid provided for cooling the active material unit,
wherein at least one portion of the housing wall is plastically or elastically deformable, so that an expansion of the active material unit due to a charging cycle and/or aging causes a deformation of the housing wall such that the cross-section of the cooling chamber is reduced at least in portions.

2. The battery cell housing according to claim 1, wherein the housing wall has at least one inner wall and at least one outer wall, wherein the cooling chamber or one of the cooling chambers is arranged between the inner wall and the outer wall.

3. The battery cell housing according to claim 2, wherein the inner wall and the outer wall are connected to one another via at least one, in particular web-like, connecting component.

4. The battery cell housing according to claim 3, wherein at least two separate cooling chambers, which are separated from each other by the connecting component.

5. The battery cell housing according to claim 2, wherein the outer wall has a higher mechanical strength than the inner wall.

6. The battery cell housing according to claim 1, wherein the battery cell housing is one piece.

7. The battery cell housing according to claim 6, wherein the battery cell housing consisting of a metal or a plastic is produced by an extrusion process or a profile extrusion process.

8. The battery cell housing according to claim 1, wherein the geometric shape of the receiving chamber is prismatic or cylindrical, so that the active material unit having a prismatic or cylindrical shape can be received therein, in particular with a precise fit.

9. The battery cell housing according to claim 1, wherein the housing wall having the cooling chamber delimits the receiving chamber laterally, in particular on the entire circumference.

10. A battery cell for an energy storage device of a motor vehicle, comprising a battery cell housing according to claim 1, and an active material unit accommodated in the receiving chamber of the battery cell housing.

11. An energy storage device for a motor vehicle, comprising multiple storage cells for storing electrical energy, wherein at least one of the storage cells is a battery cell according to claim 10.

12. The energy storage device according to claim 11, wherein the storage cells are arranged within a, in particular cuboid-shaped, energy storage housing.

13. A motor vehicle, comprising an electric machine and an energy storage device connected to the electric machine according to claim 11, wherein the electric machine is designed to generate a traction torque for the motor vehicle by electrical energy stored in the energy storage device.

14. The motor vehicle according to claim 13, further comprising a cooling system forming a cooling circuit and carrying the cooling fluid, into which the cooling chamber is integrated.

15. The battery cell housing according to claim 3, wherein the outer wall has a higher mechanical strength than the inner wall.

16. The battery cell housing according to claim 4, wherein the outer wall has a higher mechanical strength than the inner wall.

17. The battery cell housing according to claim 2, wherein the battery cell housing is one piece.

18. The battery cell housing according to claim 3, wherein the battery cell housing is one piece.

19. The battery cell housing according to claim 4, wherein the battery cell housing is one piece.

20. The battery cell housing according to claim 5, wherein the battery cell housing is one piece.
